(19) United States
(12) Patent Application Publication
(10) Pub. No.: US 2008/0291159 A1
(43) Pub. Date: Nov. 27, 2008

(54) Computer Input Device and Method for Operating the Same

(75) Inventor: Yi-Hung Wang, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 12/099,203

(22) Filed: Apr. 8, 2008

(30) Foreign Application Priority Data
May 22, 2007 (TW) 96118241

(51) Int. Cl. G09G 5/00; G06F 3/033

(52) U.S. Cl. 345/156; 345/163; 345/161

(57) ABSTRACT

An computer input device with context-awareness functionality generates a lighting pattern in response to a context of data inputting, audio, new message receiving, arranged event or system information in a computer system.

### RELATED APPLICATIONS

This application claims priority to Taiwan Application Serial Number 96118241, filed May 22, 2007, which is herein incorporated by reference.

### BACKGROUND

1. Field of Invention

The present invention relates to a computer input device and operation method thereof.

2. Description of Related Art

Conventional computer input devices (such as a keyboard or computer mouse) are only equipped with basic input function, i.e. symbol inputting or cursor position moving).

However, computer input devices as human interface devices have quite a lot to improve so as to achieve to a friendly computer command-input device.

### SUMMARY

In a first embodiment described herein, an operation method is provided for an input device with a context-awareness functionality. A sound source data output from a sound source module of a computer system is monitored. The computer input device is driven to generate a lighting pattern in response to the sound source data.

In a second embodiment described herein, an operation method is provided for an input device with a context-awareness functionality. Serial-input characters from a computer input device are monitored. When a time interval between adjacent serial-input characters is less than a predetermined time or the serial-input characters form a predetermined word or phrase, the computer input device is driven to generate a lighting pattern in response to the serial-input characters.

In a third embodiment described herein, an operation method is provided for an input device with a context-awareness functionality. A signal output from an e-mail application, a web instant messaging program or a web-based e-mail is monitored. When the signal belongs to a predetermined category, the computer input device is driven to generate a lighting pattern in response to the signal.

In a fourth embodiment described herein, an operation method is provided for an input device with a context-awareness functionality. Activities of an operation system schedule module or a schedule program application are monitored. When an predetermined event arranged by the operation system schedule module or the schedule program application is being performed, the computer input device is driven to generate a lighting pattern.

In a fifth embodiment described herein, an operation method is provided for an input device with a context-awareness functionality. A system information status within a computer system is monitored. The computer input device is driven to generate a lighting pattern in response to a predetermined system information status within a computer system.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a block diagram of a computer input device with context-awareness functionality according to a first embodiment described herein;

FIG. 2 illustrates a block diagram of a computer input device with context-awareness functionality according to a second embodiment described herein;

FIG. 3 illustrates a block diagram of a computer input device with context-awareness functionality according to a third embodiment described herein;

FIG. 4 illustrates a block diagram of a computer input device with context-awareness functionality according to a fourth embodiment described herein; and

FIG. 5 illustrates a block diagram of a computer input device with context-awareness functionality according to a fifth embodiment described herein.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

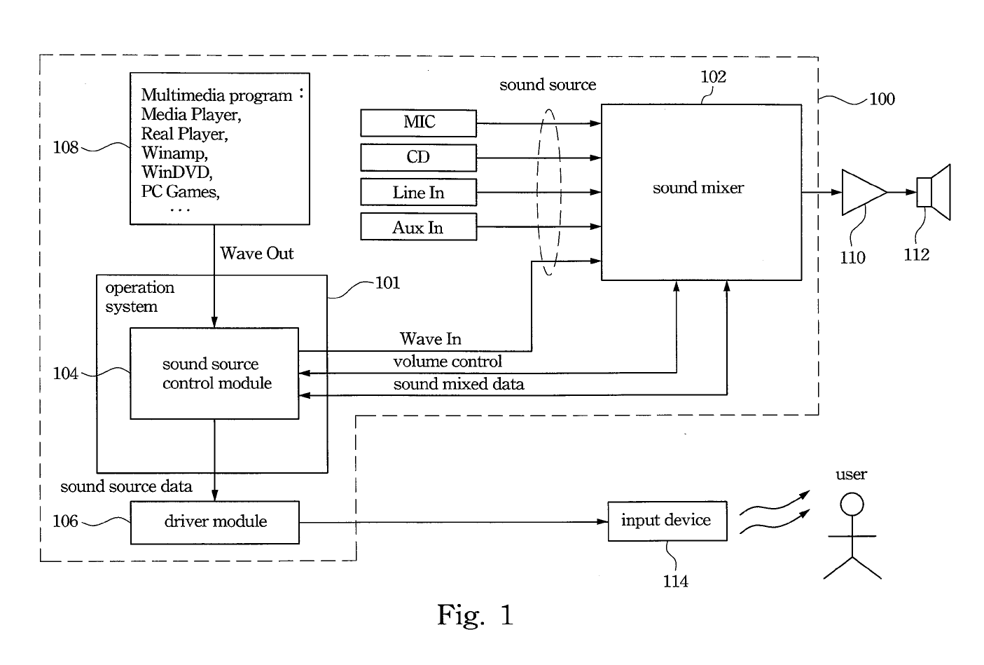

FIG. 1 illustrates a block diagram of a computer input device with context-awareness functionality according to a first embodiment described herein. In this embodiment, every sound source within a computer system can trigger a responsive lighting pattern of a computer input device 114, i.e. a keyboard, mouse, game stick or remote control device. Within an operation system 101, a sound source control module 104 receives signals, which is sent from a sound mixer 102 and contains a sound mixed data produced by the sound mixer 102, and transforms the signals into sound source data. A driver module 106 (such as a driver program) can drive the computer input device 114 to generate a lighting pattern in response to the sound source data of the sound source control module 104. In this embodiment, all sound source, whatever from microphone, CD Rom, line In or Aux In or other media play programs, are mixed by the sound mixer 102, amplified by a sound amplifier 110 and finally output by a speaker 112. What is sent or transported from the sound mixer 102 to the sound source control module 104 (i.e. sound mixed data) may contain part or all of the signals. The input device 114, which is driven by the driver module 106, can produce a corresponding lighting pattern. The lighting pattern can be bright-dark alternating, gradually-increasing bright, gradually-increasing dark, or multiple-color alternating pattern.

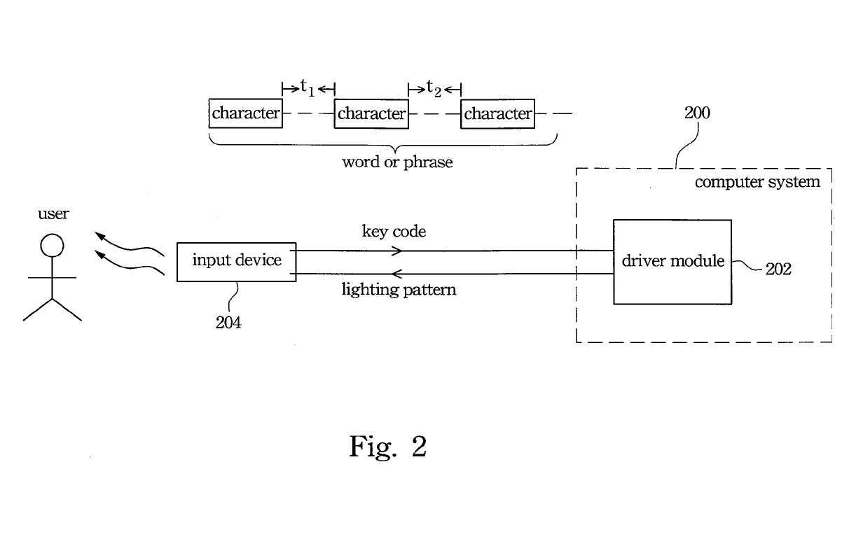

FIG. 2 illustrates a block diagram of a computer input device with context-awareness functionality according to a second embodiment described herein. In this embodiment, a driver module 202 within a computer system 200 detects serial-input characters from a computer input device 204 (such as a keyboard, mouse, game stick or remote control device). When a time interval (such as t₁ or t₂) between adjacent serial-input characters is less than a predetermined time period (such as 0.3 sec) or the serial-input characters form a predetermined word or phase (during spell checking or password confirming), the driver module 202 enables the computer input device 204 to generate a corresponding lighting pattern. Serially inputting characters rapidly can often be found in playing a computer game. The corresponding lighting pattern can be bright-dark alternating, gradually-increasing bright, gradually-increasing dark, or multiple-color alternating pattern.

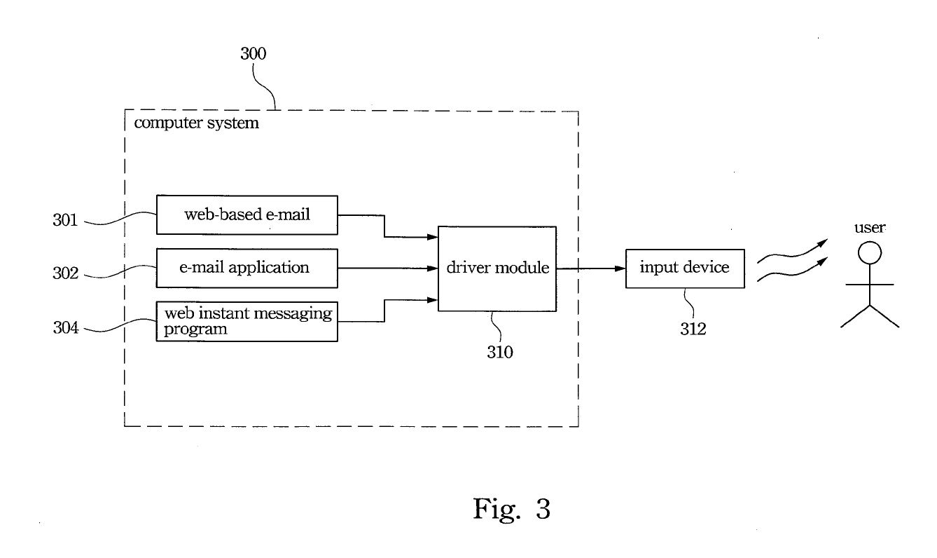

FIG. 3 illustrates a block diagram of a computer input device with context-awareness functionality according to a third embodiment described herein. In this embodiment, a driver module 310 detects a signal (such as an email, a text message or a phone ring) output from an e-mail application 302 (such as Outlook express, Outlook or Windows Mail), a web instant messaging program 304 (MSN Messenger, Yahoo Messenger, Google Talk or Skype) or web-based e-mail (such as Gmail, Yahoo mail or Hotmail) within a computer system 300. When the signal belongs to a specified category (such as high-priority email, text message or phone ring), the driver module 310 enables the computer input device 312 (such as a keyboard, mouse, game stick or remote control device) to generate a corresponding lighting pattern. The corresponding lighting pattern can be bright-dark alternating, gradually-increasing bright, gradually-increasing dark, or multiple-color alternating pattern.

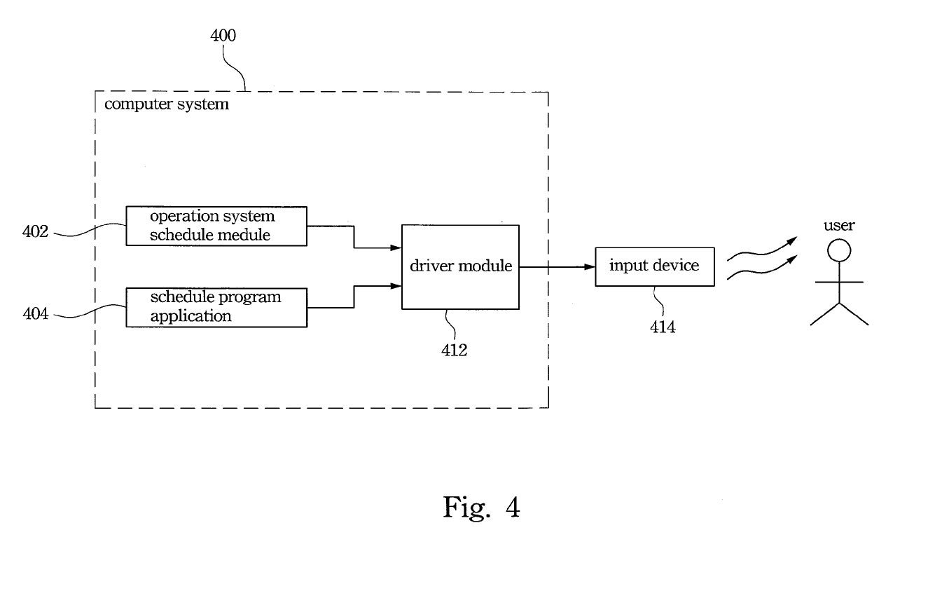

FIG. 4 illustrates a block diagram of a computer input device with context-awareness functionality according to a fourth embodiment described herein. In this embodiment, a driver module 412 detects activities of an operation system schedule module 402 (such as Task Scheduler of Windows) or a schedule program application 404 (such as Outlook calendar or Windows calendar). When events arranged by the operation system schedule module 402 or the schedule program application 404 are performed, the driver module 412 enables the computer input device 414 (such as a keyboard, mouse, game stick or remote control device) to generate a corresponding lighting pattern. The corresponding lighting pattern can be bright-dark alternating, gradually-increasing bright, gradually-increasing dark, or multiple-color alternating pattern.

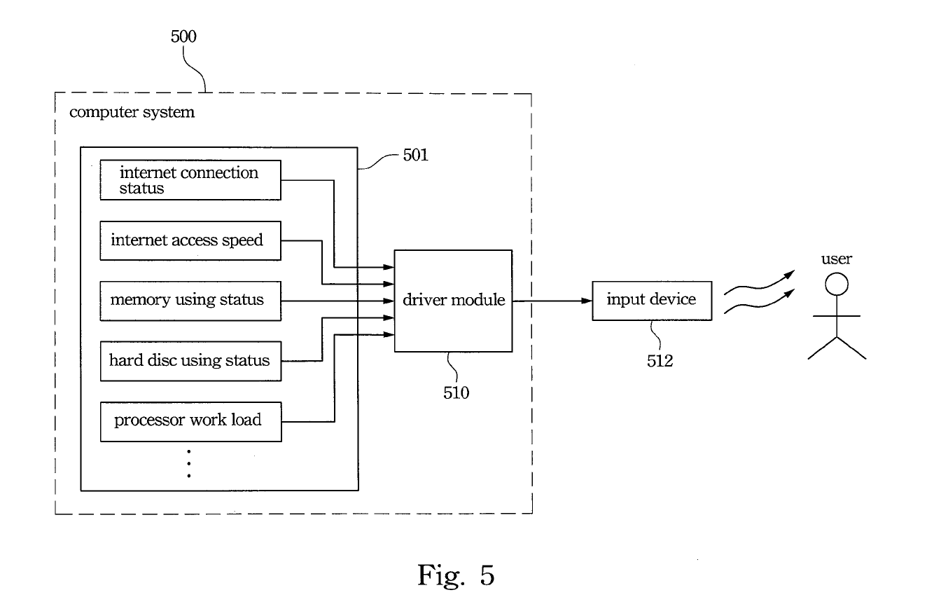

FIG. 5 illustrates a block diagram of a computer input device with context-awareness functionality according to a fifth embodiment described herein. In this embodiment, a driver module 510 detects a system information status (Internet connection status, Internet access speed, memory using status, hard disc using status or processor workload) of a computer system 500. When a specified system information status occurs (such as Internet connection break, insufficient memory, insufficient hard disc storage or processor overload), the driver module 510 enables the computer input device 512 (such as a keyboard, mouse, game stick or remote control device) to generate a corresponding lighting pattern. The corresponding lighting pattern can be bright-dark alternating, gradually-increasing bright, gradually-increasing dark, or multiple-color alternating pattern.

According to discussed embodiments, a computer input device with a context-awareness functionality is able to provide more interactions between the computer input device and a user so as to enhance friendliness and entertainment thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation method for an input device with a context-awareness functionality, the operation method comprising:
detecting a sound source data output from a sound source module of a computer system; and
driving the computer input device to generate a lighting pattern in response to the sound source data.

2. The operation method of claim 1, wherein the input device comprises a computer keyboard or a computer mouse.

3. The operation method of claim 1, wherein the input device comprises a game stick or a remote control device.

4. The operation method of claim 1, wherein the sound source data is output from a sound mixer of the computer system.

5. The operation method of claim 1, wherein the lighting pattern comprises a bright-dark alternating pattern, a gradually-increasing bright pattern, a gradually-increasing dark pattern or a multiple-color alternating pattern.

6. An operation method for a computer input device with a context-awareness functionality, the operation method comprising:
detecting serial-input characters from a computer input device; and
driving the computer input device to generate a lighting pattern in response to the serial-input characters when a time interval between adjacent serial-input characters is less than a predetermined time or the serial-input characters form a predetermined word or phrase.

7. The operation method of claim 6, wherein the input device comprises a computer keyboard or a computer mouse.

8. The operation method of claim 6, wherein the input device comprises a game stick or a remote control device.

9. The operation method of claim 6, wherein the lighting pattern comprises a bright-dark alternating pattern, a gradually-increasing bright pattern, a gradually-increasing dark pattern or a multiple-color alternating pattern.

10. An operation method for a computer input device with a context-awareness functionality, the operation method comprising:
detecting a signal output from an e-mail application, a web instant messaging program or a web-based e-mail; and
driving the computer input device to generate a lighting pattern in response to the signal when the signal belongs to a predetermined category.

11. The operation method of claim 10, wherein the input device comprises a computer keyboard or a computer mouse.

12. The operation method of claim 10, wherein the input device comprises a game stick or a remote control device.

13. The operation method of claim 10, wherein the signal comprises an e-mail, a text message or a phone ring.

14. The operation method of claim 10, wherein the lighting pattern comprises a bright-dark alternating pattern, a gradually-increasing bright pattern, a gradually-increasing dark pattern or a multiple-color alternating pattern.

15. An operation method for a computer input device with a context-awareness functionality, the operation method comprising:
detecting activities of an operation system schedule module or a schedule program application; and
driving the computer input device to generate a lighting pattern when an predetermined event arranged by the operation system schedule module or the schedule program application is being performed.

16. The operation method of claim 15, wherein the input device comprises a computer keyboard or a computer mouse.

17. The operation method of claim 15, wherein the input device comprises a game stick or a remote control device.

18. The operation method of claim 15, wherein the lighting pattern comprises a bright-dark alternating pattern, a gradually-increasing bright pattern, a gradually-increasing dark pattern or a multiple-color alternating pattern.

19. An operation method for a computer input device with a context-awareness functionality, the operation method comprising:
detecting a system information status within a computer system; and
driving the computer input device to generate a lighting pattern in response to a predetermined system information status within a computer system.

20. The operation method of claim 19, wherein the system information status comprises Internet connection status, Internet access speed, memory using status, hard disc using status or processor workload.

21. The operation method of claim 19, wherein the input device comprises a computer keyboard or a computer mouse.

22. The operation method of claim 19, wherein the input device comprises a game stick or a remote control device.

23. The operation method of claim 19, wherein the lighting pattern comprises a bright-dark alternating pattern, a gradually-increasing bright pattern, a gradually-increasing dark pattern or a multiple-color alternating pattern.
